(19) United States
(12) Patent Application Publication
(10) Pub. No.: US 2014/0095108 A1
(43) Pub. Date: Apr. 3, 2014

(54) APPARATUS AND SYSTEM FOR MEASURING THE AMOUNT OF WASTE FOOD REDUCED BY A WASTE FOOD MACHINE

(71) Applicant: Iain Milnes, Fremont, CA (US)

(72) Inventor: Iain Milnes, Fremont, CA (US)

(21) Appl. No.: 13/631,790

(22) Filed: Sep. 28, 2012

(51) Int. Cl. G06F 15/00

(52) U.S. Cl. 702/173

(57) ABSTRACT

An apparatus comprises a weight sensing unit being configured to be operable for measuring a weight of at least a drum portion of a waste food machine and an incremented weight with waste food placed in the drum. A processing unit in communication with the weight sensing unit is at least configured to be operable for obtaining measurements from the weight sensing unit at periodic times, for generating data from the measurements for at least determining a first weight of waste food placed in the drum, a second weight of the waste food after the waste food machine has processed the waste food, and an amount of the waste food that has been diverted from a landfill by the processing of the waste food by the waste food machine.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relates to waste management. More particularly, one or more embodiments of the invention relates to measuring the amount of waste food eliminated or reduced by a waste food machine.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. A waste food machine is a machine that is usually installed in a business that produces large quantities of waste food such as, but not limited to, commercial kitchens, cafeterias, sports arenas, convention centers, cruise ships, theme parks, resorts, supermarkets, etc. One can expect that the use of these machines may save or reduce the mess, cost, and inconvenience of sending waste food to a landfill. When waste food is sent to a landfill, it generally decomposes to methane (CH4) which is generally released to the atmosphere. It is believed that the release of CH4 is harmful to the atmosphere, maybe as much as 72 times worse for the atmosphere than CO2. Many businesses that generate waste food are realizing the implications of their waste food on the environment and that the use of a waste food machine can help to reduce their carbon footprint. Currently, there are three types of such machines that are typically used, a wet type, a dry type, and hybrid types. With the wet type of machine, waste food is typically put into the machine where it is decomposed and the output is sent as grey water down the drain. With the dry type of machine, waste food is typically dehydrated reducing the volume significantly. The output from a dry type of machine can be disposed in various different ways, for example, without limitation, sent to a landfill, sent for further processing to make compost, used as a soil amendment, etc. Hybrid type machines can combine wet decomposition and dehydration.

FIG. 1 is a partially cut away side view of an exemplary waste food machine, in accordance with the prior art. Waste food machines may vary in size, with typical industrial machines digesting from 50 kg per day to 1000 kg per day. Such devices may vary from about 90 cm wide to 250 cm wide. Many such machines are constructed mostly of stainless steel. For a wet type of machine and referring to FIG. 1, a chassis 1 supports a drum 2 and a motor 3. In general, waste food is put into drum 2 through a door 4. Motor 3 drives a shaft 5 with arms 6 through a chain, belt, or system of gears 7. Motor 3 causes arms 6 to rotate slowly (for example at about one revolution every five seconds) to mix old waste food with new waste food. Water may be added through an inlet 8 to maintain the correct moisture content in drum 2 for the decomposition process. The decomposition of the waste food may be accelerated by the addition of a blend of microorganisms and enzymes that are added periodically to drum 2 either automatically by additive releasing means 9 or manually through door 4. Digested material exits the machine to a drain through a pipe 10. Chassis 1 is often supported on supports 11. There are typically four such supports 11. In some machines these supports may be combined with wheels to allow the machine to be moveable. An outer casing 12 is usually made of stainless steel.

For a dry type of machine, the structure is similar to the wet type. However, water and microorganisms are not typically added to the machine. Usually, the machine is loaded with waste food, the door is closed, and the machine heats the waste food. Typically, the temperature is raised to 90° C. for six hours and a cycle takes about 18 hours. The machine may churn the waste during this process with the objective of breaking it into small pieces. At the end of the cycle, the dehydrated waste is emptied through an output door, which is typically not present on the wet type of machine. The dehydrated waste is typically 10% of the original volume of waste food. A hybrid type machine may start with a decomposition process similar to a wet type of machine, and, after a certain time, for example, without limitation, 12 hours, the machine may then dry the remainder of the waste food similar to a dry type of machine. For any type of machine (e.g., wet, dry, or hybrid), the machine normally runs only when the door or doors are closed. For a wet type of machine, the door may be opened at any time so that additional waste food or additives can be added. For a dry type of machine, the methodology is a batch process, so once the process is started the door is kept closed and typically no further waste food can be added until the process is complete.

A waste food machine disposes of waste food or reduces its volume and weight. In some instances, a user or owner of such a machine may wish to know how much waste food is processed by the machine and hence diverted from a landfill. For example, without limitation, this knowledge may be required for reporting to governmental agencies or for reporting to shareholders and customers of the company to demonstrate the company's commitment to environmental sustainability. Currently, a waste management company may charge a customer a fee based on the weight of trash that is collected or taken to the landfill. Such a company may provide a waste food machine to a customer and want to charge the customer a usage charge based on the weight of waste food consumed or reduced by the machine. It is believed that current machines generally do not have means for automatically measuring the amount of food processed by the machines.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, an aspect of the prior art generally useful to be aware of is that users of waste food machines may weigh the waste food prior to putting the food into the waste food machine. However, most kitchens are generally busy, and such a scheme is cumbersome and provides more data than required. In addition, some machines that process waste food currently exist that have strain gauges or load cells to identify when the machine can accept more waste food. The indication on such machines is usually a “traffic light” type of display that shows red, amber, or green.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a partially cut away side view of an exemplary waste food machine, in accordance with the prior art;

FIG. 2 is a partially cut away side view of an exemplary waste food machine, in accordance with an embodiment of the present invention;

FIG. 3 illustrates an exemplary process for generating an output from the data collected by weight measuring devices, in accordance with an embodiment of the present invention;

FIG. 4 is a side view of an exemplary waste food machine, in accordance with an embodiment of the present invention;

FIG. 5 is a side view of an exemplary waste food machine, in accordance with an embodiment of the present invention; and

FIG. 6 illustrates a typical computer system that, when appropriately configured or designed, can serve as a computer system in which the invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternative and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. In addition, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application for particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived there from.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions, or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention may provide a means and a method for automatically calculating and reporting the amount of waste food diverted from a landfill by a waste food machine. As a waste food machine processes waste food, some embodiments may keep track of the amount of food processed and report this information to a user through a display on the machine or by sending the data to a remote computer or database. Some embodiments record the weight of the machine plus waste food each time a door of the machine is opened or closed. From these totals, software included, without limitation, in these embodiments can calculate the weight of waste food that is processed by the machine. From there, these embodiments may be able to create totals such as, but not limited to, per day or per month weights and report these totals to a user or to a remote database.

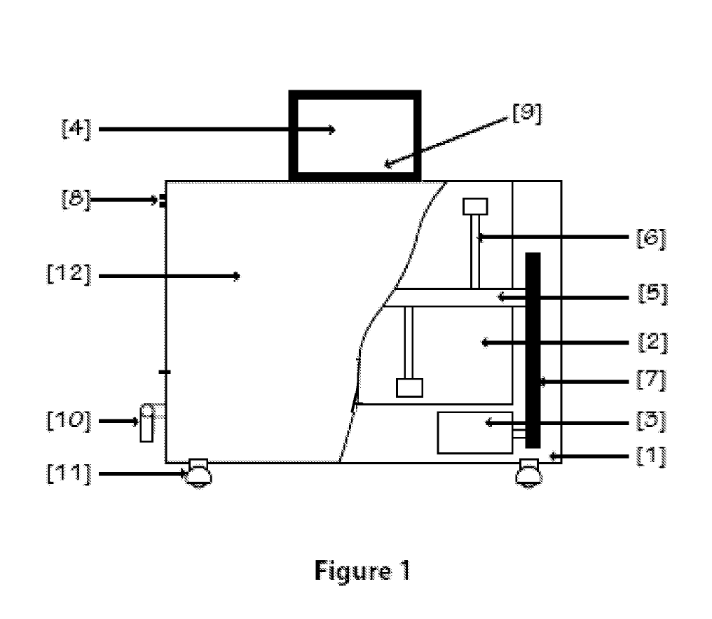

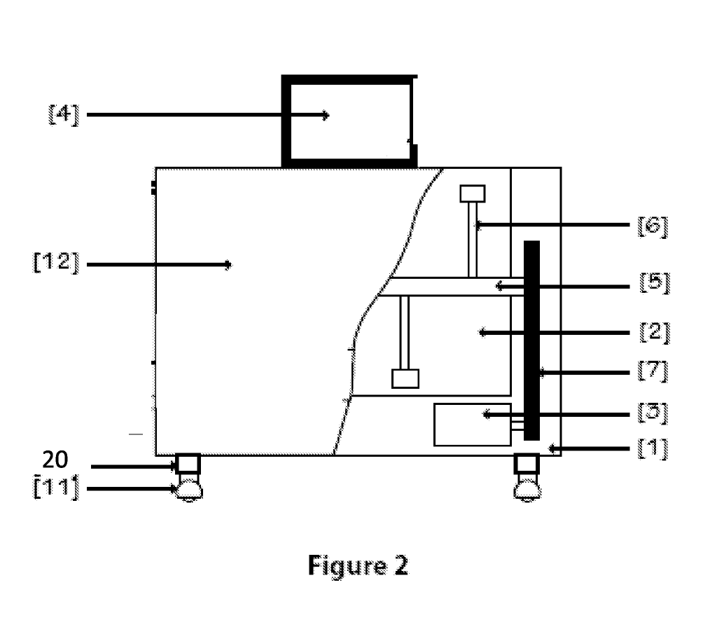

FIG. 2 is a partially cut away side view of an exemplary waste food machine, in accordance with an embodiment of the present invention. In the present embodiment, the waste food machine is similar to the basic waste food machine shown by way of example in FIG. 1 and comprises a chassis 1, a drum 2, a motor 3, and a door 4. Motor 3 drives a shaft 5 with arms 6 through a chain, belt, or system of gears 7. If the machine is a wet or hybrid machine, an inlet for water, an outlet pipe and additive releasing means may also be included, without limitation. If the machine is a dry machine, the machine may comprise an outlet door through which dehydrated material may be removed. Chassis 1 is supported on supports 11 and is covered by an outer casing 12, which is usually made of stainless steel. In some embodiments, the outer casing may be made of various different materials as, but not limited to, various different metals or plastics.

In the present embodiment, the machine is modified to comprise one or more weight measuring devices 20 at one or more of supports 11. Some non-limiting examples of weight measuring devices may include without limitation load cells or strain gauges. Some embodiments may comprise four, two, or one weight measuring devices. If there are four weight measuring devices, the sum of all the measured weights from the devices is the total weight of the machine plus waste food. Alternatively, two weight measuring devices may be placed on one side of the machine so that the sum of the measured weights from the devices is approximately half of the total weight of the machine plus waste food. If only one weight measuring device is used, the measured weight from the device is approximately a quarter of the total weight of the machine plus waste food. Other embodiments may comprise virtually any number of weight measuring devices. Furthermore, some alternative embodiments may be implemented without supports. The weight measuring devices in these embodiments may be placed virtually anywhere in or on the machine. No matter how many weight measuring devices are used, the system typically must be calibrated to account for placement of the weighing devices and inaccuracies.

The signals from weight measuring devices 20 are processed by a microprocessor. The zero weight is usually calibrated when the machine has no waste food, and thereafter the microprocessor can generally determine how much waste food is added or consumed by the machine. This information may be reported through a display on the waste food machine, as a printed report, or sent through a network or other interface to a computer, phone, user, or database. The amount of waste food consumed may be reported along with other information, including, without limitation, statistics about periodic totals, averages, and the timing or frequency of the consumption, reduction, or diversion of the waste food. If sent to a database, the data may be accessed for example by the user, owner, service technician, or operator of the machine. In addition, the data may be accessed by another computer program to create reports or invoices for customers or authorities. This typically enables that person or organization to report the amount of waste food that is being diverted from a landfill, to bill the user, report costs or money saved, reduction in carbon emissions, etc. This information also enables the user, owner, service technician, or operator to schedule visits to service a machine, including, without limitation, when consumable items need to be replaced or supplemented. Waste food machines according to some embodiments of the present invention may be used by restaurants, hotels, banquet facilities, culinary schools, bakeries, supermarkets, food processing facilities, resorts, theme parks, private yachts, cruise ships, corporations, schools, canteens in limitary institutions such as prisons and so on, stadia, convention centers, and other such commercial, industrial, private, or military establishments. These machines can save these entities the mess, cost, and inconvenience of sending waste food to a landfill. Furthermore, some organizations may want to report how much waste is diverted from a landfill. Other organizations such as, but not limited to, highway service centers or waste management companies who may supply the machines to users, may want this information to charge these users for the use of the machines.

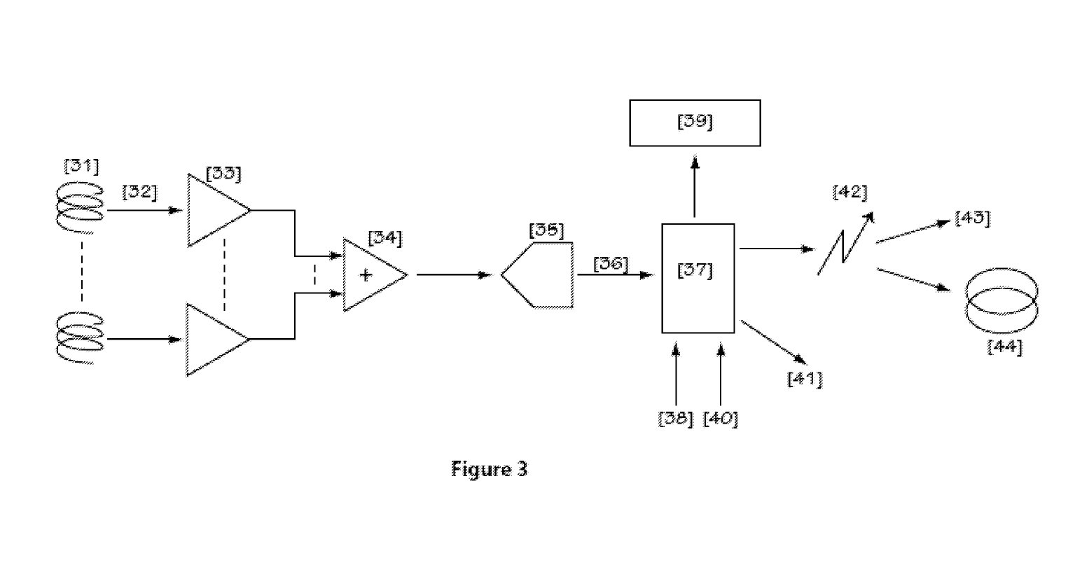

FIG. 3 illustrates an exemplary process for generating an output from the data collected by weight measuring devices 31, in accordance with an embodiment of the present invention. In the present embodiment, an electronic signal or signals 32 are output from a weight measuring device or devices 31 and is conditioned to a usable level through one or more amplifiers and filters 33. If there is more than one signal, these signals are added together with a summing amplifier 34 and then converted by an analog to digital converter 35 to a digital signal 36. In some embodiments, various parts of 33, 34, and 35 may be integrated and some of these may be integrated with the measuring devices 31 or the microprocessor 37. Alternatively, combinations of the analog signals from the weight measuring devices may be converted to more than one digital signal rather than summing the analog signals. A microprocessor system 37 then reads the total weight from digital signal or signals 36, summing the signals if there is more than one signal.

At some point, for example, without limitation, at the factory or after the machine has been installed, microprocessor 37 reads the weight of the machine when there is no waste food in the machine and determines that to be the zero point. This is accomplished by the operator using buttons or keys 38 and looking at a display 39. After the zero point has been established, any additional weight detected by weight measuring devices 31 is assumed to be due to waste food in the machine and water and microorganisms or other additives if the machine is a wet type of machine. In the present embodiment, the weight of water and microorganisms can be ignored and the additional weight can be assumed to be solely that of the waste food since, over time, the machine reaches a balance whereby the amount of water being added runs out through an outlet pipe to the drain. However, in some embodiments, an estimate of the weight of the water may be made and used in the calculation.

In the present embodiment, a switch is in some way connected to the door of the machine such as, but not limited to, a push button or a circuit that is completed when the door is closed. This switch creates a signal 40 that is fed to microprocessor 37 to indicate whether the door is open or closed. In the present embodiment, microprocessor 37 controls a motor to open and close the door through a signal 41. In some embodiments in which the microprocessor controls the door, a signal indicating whether the door is opened or closed may not be present, and instead the microprocessor comprises an equivalent internal signal to indicate when the door is opened or closed. Other embodiments may be implemented in which the microprocessor does not control the opening and closing of the door.

For a wet type of machine, according to the present embodiment, when the door is opened, microprocessor 37 records the weight of the waste food, herein referred to as A. When the door is closed, the microprocessor records the weight again, herein referred to as B. The difference between these two measurements (B−A) is approximately the weight of the waste food that has been added and diverted from the landfill. Waste food can be continuously added, and each time waste food is added the microprocessor can accumulate the total amount of waste food. For a dry type of machine according to the present embodiment, microprocessor 37 records the weight, at the start of the process after the waste food has been added and the door is closed, herein referred to as C. At the end of the batch process, microprocessor 37 again records the weight, herein referred to as D. In a dry machine, waste is typically emptied at the end of the batch process through an output door. Microprocessor 37 records the weight after the dried waste is expunged and the output door is closed, herein referred to as E. The amount of waste diverted from the landfill is C−D+E. Again, microprocessor 37 can accumulate the total amount of waste food. For a hybrid type of machine according to the present embodiment, when the input door is opened, microprocessor 37 records the weight of the waste food, herein referred to as F. When the door is closed, microprocessor 37 records the weight again, herein referred to as G. The difference between these two measurements (G−F) is the approximate weight of the waste food that has been added and diverted from the landfill as it is assumed that any residue waste is used as fertilizer and not sent to the landfill. If this waste residue is sent to the landfill the weight of the residue may be measured and subtracted from the total. Waste food may be continuously added, and each time waste food is added microprocessor 37 can accumulate the total amount of waste food.

For a wet type, dry type, or hybrid type machine in accordance with the present embodiment, the amount of waste food that is consumed or reduced can be accumulated by microprocessor 37 at almost any interval of time such as, but not limited to, a day, a week, or a month. This data, including statistics about the operation of the machine, can be displayed to an operator on display 39 by means of interaction through buttons or keys 38. By using a network or other means of connectivity 42, this data about the statistics of the operation of the machine and the accumulations in unit time of waste food may be sent to a user 43 or a database 44. Some non-limiting examples of means of connectivity 42 include, without limitation, ZigBee, Wi-Fi, Ethernet, Bluetooth, USB, LAN, the internet, GSM, or CDMA. In some embodiments, the data can be sent over a GSM or CDMA network through the use of a modem internal or external to the waste food machine, or the data could be sent as a data packet or as an SMS. In the present embodiment, user 43 may receive the data at a specific device such as, but not limited to, a display, computer, phone, etc. This device may be connected directly to the waste food machine, for example, without limitation, using Wi-Fi, Ethernet, Bluetooth, or USB, or may be remote with the data sent over the internet or a telephone network. A database 44 may also be remote and may be accessed by user 43 or another individual such as but not limited to, an owner, service technician, or operator of the waste food machine to see reports of the usage of the waste food machine and the amount of waste food that is being diverted from the landfill. Database 44 may accumulate the data from multiple waste food machines and a user, owner, service technician, or operator of multiple waste food machines can view such data from such multiple machines separately or in an aggregated form. This data could also be accessed and processed by another computer program. The data, processed or unprocessed, may be used by a waste management company that is likely to manage multiple waste food machines. The waste management company can view or access the same data and can bill the customer for the amount of waste food diverted from the landfill.

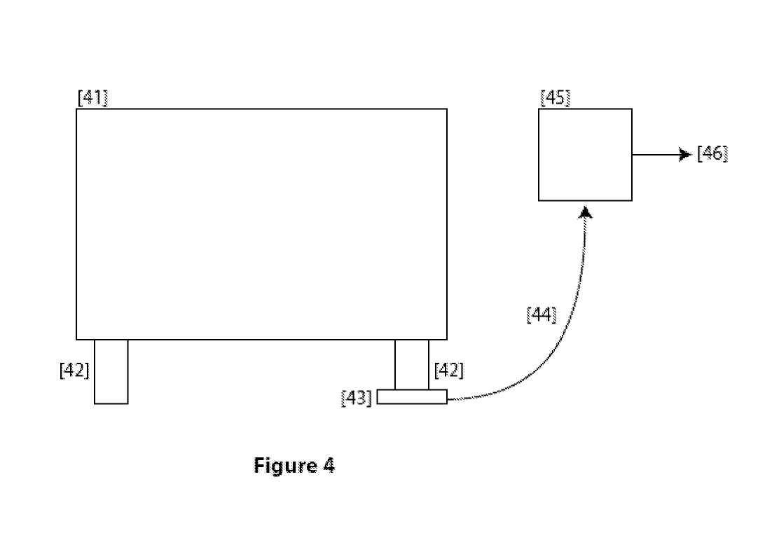

FIG. 4 is a side view of an exemplary waste food machine 41, in accordance with an embodiment of the present invention. In the present embodiment, a weight measuring device 43, or multiple devices, is or are placed under one or more of supporting legs 42 of waste food machine 41. As such, the weighing mechanism is not incorporated into the waste food machine itself. The output or outputs 44 from the weight measuring device 43 is or are fed to a processing device 45 that likely has a display and a means for user input such as, but not limited to, buttons, keys, a touch screen, a mouse, etc. Processing device 45 may be separate from, attached to, or incorporated into waste food machine 41. Processing device 45 may process the data related to the quantity and timing of the disposal of waste food as described in the foregoing paragraphs and may send that data either processed or unprocessed to a user, a computer, or a database by a means of connection 46. Weight measuring device 43 may be almost any type of weight measuring means such as, but not limited to, a commercially available scale with an electronic output. Also, processing device 45 may be a virtually any type of processing means including, without limitation, a commercially available industrial computer with a touch screen display, a commercially available PC with a separate display, a tablet computer, etc.

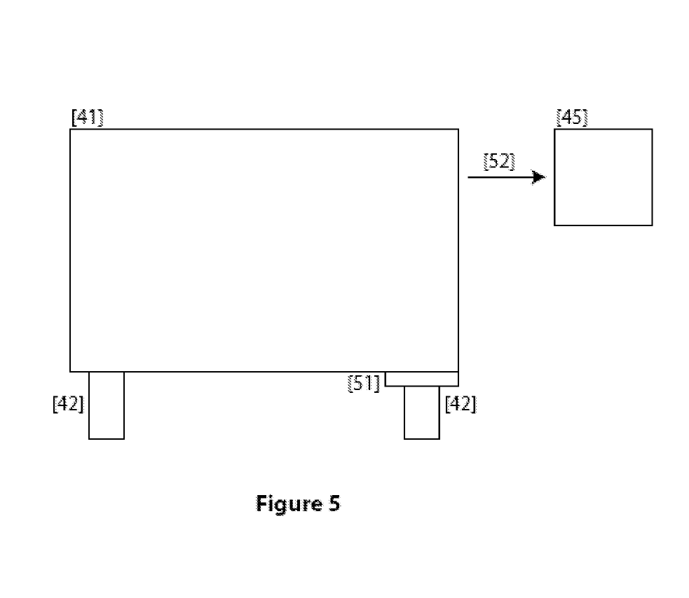

FIG. 5 is a side view of an exemplary waste food machine 41, in accordance with an embodiment of the present invention. In the present embodiment, one or more weight measuring devices 51 that are suitable for weighing waste food machine 41 are incorporated into waste food machine 41 at supporting legs 42. A signal or signals 52 from weight measuring device or devices 51 are fed to a processing device 45. Signals 52 may undergo pre-processing internal to the waste food machine 41 before reaching processing device 45.

Referring to FIG. 4 and FIG. 5, information about the state of the door, or doors, of waste food machine 41 may or may not be fed from machine 41 to processing device 45. If information about the state of the door is not provided to processing device 45, processing device 45 may be able to determine when the doors are opened using various different means such as, but not limited to, the algorithms that follow. For a wet type of machine, processing device 45 may constantly evaluate the minimum weight of the machine. At any time there is an increase in weight, for example, without limitation, by 1%, processing device 45 determines that waste food has been added to the machine and the weight has passed a minimum point, M. The processing device continues to record the weight of the machine until the weight reaches a maximum level, N, and begins to decrease, for example, without limitation, by 1%. The difference between these two measurements (N−M) is approximately the weight of the waste food that has been added and diverted from the landfill. For a dry type of machine, the processing device 45 constantly evaluates the weight of the machine. At any time there is a sudden decrease in the weight of the machine, for example, without limitation, by 1% in a minute, the processing device 45 can determine that the output door has been opened. The weight just prior to this event is herein referred to as P. At a minimum weight, Q, the processing device 45 assumes that the machine has been emptied. As the machine is filled again for the next batch, the processing device 45 records the maximum weight R. The algorithm is the same as that described above. Namely, the weight of waste food reduced by the waste food machine is R−P+Q.

In some embodiments, the waste food machine may not accumulate the weight directly and report it. Instead, the machine may indicate to a user that the machine can accommodate more waste food, for example, without limitation, with a green LED. The user may then add waste food until the machine is full, which may be indicated for example, without limitation, with an orange LED. If the user continues to add waste food, the machine may indicate an overload, for example, without limitation, with a red LED. In the case of an overload, the user may be prompted to remove waste food from the machine until the overload is removed, for example, without limitation, indicated by a yellow LED. Once the overload is removed, the user may close the door to begin the process. When more waste food can be added, the machine may prompt the user of this, for example, without limitation, with the green LED, and the process can repeat. In these embodiments, the machine may count the number of times the door is opened and closed and from that estimate how much waste food is consumed.

It is contemplated that other embodiments may be implemented without using a signal that indicates if the door is opened or closed. In these embodiments, it may be deduced by the machine that waste food has been put into the machine by noting that the weight of the machine has increased. For example, without limitation, an indication that the weight had increased a few percent may indicate that waste food has been added. The weight prior to the deduction is the minimum weight recorded. Then, the software starts a process to calculate how much waste food has been inserted by detecting the maximum weight after the machine detects a minor increase in weight. As soon as the weight starts to decrease, the software can deduce that the door has been closed and can use these maximum and minimum weights to decide how much waste food has been put into the machine. In other embodiments the readings of the weight of the waste food machine, which typically includes the weight of the machine and the weight of the waste food, may be sent periodically, for example, without limitation, every second or every minute, to a remote computing unit. That computing unit processes the data and deduces the amount of waste food that has been consumed or reduced by the machine and hence the weight of waste food that has been diverted from a landfill.

In other embodiments, the control feature may not be incorporated into the machine. Instead, the controller may be external to the machine. Furthermore, in some embodiments, the weight measuring devices may not necessarily be incorporated into the machine, and external scales onto which the machine is placed may be used. In these embodiments, the process of determining the amount of waste food consumed by the machine may be accomplished without modifying a basic waste food machine. Such a solution may be sold as an option to new sales of waste food machines or as an after-market add-on to machines already in use. As an example of these embodiments, the system comprises weighing scales that output signals to a computer, for example, without limitation, a control panel computer with a touch screen display. In some embodiments, one or more additional mechanisms may be added that indicates to the computer when the door (or doors) is or are opened and closed, or the computer may determine when the door is opened and closed and when waste food is added by algorithms like those described above or similar without needing signals from the door or doors. It is contemplated that in other embodiments some elements of the system may be incorporated into the machine such as, but not limited to, the load cells, while other elements are external to the machine.

In yet other embodiments, the weight measuring devices may be placed inside the machine where the devices may be protected from the elements and from damage in transit and after installation. In these embodiments a mechanism to weigh the drum may be used. For this mechanism, the drum is mounted on a separate chassis within the main chassis and the weighing devices may be beneath this sub chassis or may form part of the structure to suspend the sub chassis from above. The motor may or not be mounted on the sub chassis. If a chain is used to drive the shaft, the chain may be located to easily accommodate movements in the sub chassis if the motor is mounted on the main chassis.

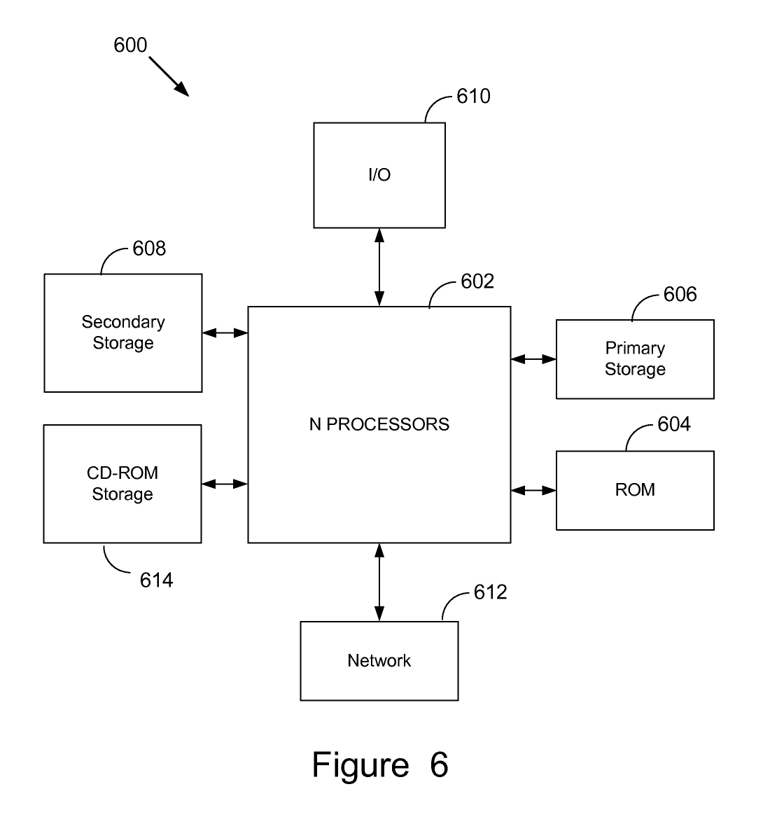

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable non-transitory computer-readable media such as those described above. A mass storage device 608 may also be coupled bi-directionally to CPU 602 and provides additional data storage capacity and may include any of the non-transitory computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in light of and in accordance with the teachings of the present invention, that any of the foregoing steps may be suitably replaced, reordered, or removed, and additional steps may be inserted depending upon the needs of the particular application. Moreover, the prescribed methods or steps of the foregoing embodiments may be implemented using any physical and/or hardware system that those skilled in the art will readily know is suitable in light of the foregoing teachings. For any methods or steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of providing means for determining how much waste food is consumed by a waste food machine according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of processor used. The processors described in the foregoing were directed to internal implementations; however, similar techniques are to provide processors that are external to the machine. This processor may be sold as an option to a basic waste food machine. Implementations of the present invention comprising external processors are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a weight sensing unit being configured to be operable for measuring a weight of at least a drum portion of a waste food machine and an incremented weight with waste food placed in the drum; and
a processing unit in communication with said weight sensing unit, said processing unit at least being configured to be operable for obtaining measurements from said weight sensing unit at periodic times, for generating data from said measurements for at least determining a first weight of waste food placed in said drum, a second weight of the waste food after the waste food machine has processed the waste food, and an amount of the waste food that has been diverted from a landfill by the processing of the waste food by the waste food machine.

2. The apparatus as recited in claim 1, in which said periodic times at least comprises times when a waste food access door of the waste food machine is opened and closed.

3. The apparatus as recited in claim 1, in which said generated data further comprises statistics comprising periodic totals, averages, and frequency of the waste food processing.

4. The apparatus as recited in claim 3, in which said processing unit is further configured to be operable for displaying said generated data to a user of the waste food machine.

5. The apparatus as recited in claim 4, in which said processing unit is further configured to be operable for communicating said generated data to a computing device for further processing.

6. The apparatus as recited in claim 5, in which said further processing at least comprises determining a bill for the user.

7. The apparatus as recited in claim 6, in which said further processing further comprises generating reports on the operation of the waste food machine.

8. The apparatus as recited in claim 7, in which said further processing further comprises determining times for servicing of the waste food machine.

9. The apparatus as recited in claim 1, in which said weight sensing unit is further configured to be operable for measuring a total weight of the waste food machine and an incremented weight of waste food placed in the waste food machine.

10. The apparatus as recited in claim 9, in which said weight sensing unit further comprises a plurality of weight sensors being joinable to supporting structures of the waste food machine.

11. An apparatus comprising:
means being configured to be operable for measuring a weight of at least a drum portion of a waste food machine and an incremented weight with waste food placed in the drum portion; and
means, in communication with said measuring means, at least being configured to be operable for obtaining measurements from said weight sensing unit at periodic times, for generating data from said measurements for at least determining a first weight of waste food placed in said drum, a second weight of the waste food after the waste food machine has processed the waste food, and an amount of the waste food that has been diverted from a landfill by the processing of the waste food by the waste food machine.

12. A system comprising:
a waste food machine being configured for processing waste food to reduce a volume of the waste food, said waste food machine at least comprising a plurality of supporting structures, a drum portion for receiving the waste food, an access door for accessing said drum portion for placement of the waste food therein, and a motorized mechanism for performing operations during said processing;
a weight sensing unit being joined to said waste food machine, said weight sensing unit being configured to be operable for measuring a weight of at least said drum portion and an incremented weight with waste food placed in said drum portion; and
a processing unit in communication with said weight sensing unit, said processing unit at least being configured to be operable for obtaining measurements from said weight sensing unit at periodic times at least comprising times when said access door is opened and closed to indicate placement of waste food into said drum portion, for generating data from said measurements at least comprising a determination of a first weight of waste food placed in said drum portion, a determination of a second weight of the waste food after said waste food machine has processed the waste food, and an amount of the waste food volume that has been reduced by said processing of the waste food by said waste food machine and diverted from a landfill, and for displaying said generated data to a user of said waste food machine; and
a communications unit for communicating said generated data to a computing device for further processing.

13. The system as recited in claim 12, in which said generated data further comprises statistics comprising periodic totals, averages, and frequency of said waste food processing.

14. The system as recited in claim 13, in which said further processing at least comprises determining a bill for the user.

15. The system as recited in claim 13, in which said further processing further comprises generating reports on the operation of the waste food machine.

16. The system as recited in claim 13, in which said further processing further comprises determining times for servicing of the waste food machine.

17. The system as recited in claim 12, in which said weight sensing unit is further configured to be operable for measuring a total weight of the waste food machine and an incremented weight of waste food placed in the waste food machine.

18. The system as recited in claim 17, in which said weight sensing unit further comprises a plurality of weight sensors being joined said supporting structures.

19. The system as recited in claim 18, in which said supporting structures comprise legs.

20. The system as recited in claim 19, in which a weight sensor is joined to each of said legs.

21. The system as recited in claim 12, in which said waste food machine comprises a wet machine.
